(19) United States
(12) Patent Application Publication
(10) Pub. No.: US 2026/0173094 A1
(43) Pub. Date: Jun. 18, 2026

(54) METHOD AND APPARATUS FOR DETERMINING UNIFIED TRANSMISSION CONFIGURATION INDICATOR STATE, AND STORAGE MEDIUM

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(73) Assignee: BEIJING XIAOMI MOBILE SOFTWARE CO., LTD., Beijing (CN)

(21) Appl. No.: 19/127,616

(22) PCT Filed: Nov. 6, 2022
(86) PCT No.: PCT/CN2022/130177

§ 371 Date: May 6, 2025

(51) Int. Cl. H04W 72/23; H04L 5/00

(52) U.S. Cl. CPC H04W 72/23; H04L 5/0048; H04L 5/0053

(57) ABSTRACT

The present disclosure relates to a method for determining a Unified TCI state. The method includes: receiving first indication information sent by a network device, the first indication information being configured for indicating a control resource pool index of at least one Control Resource Set. Different control resource pool indexes correspond to different Unified TCI state lists.

### CROSS REFERENCE TO RELATED APPLICATIONS

The present disclosure is the U.S. national phase application of International Application No. PCT/CN 2022/130177, filed on Nov. 6, 2022, the content of which is incorporated herein by reference in its entirety for all purposes.

### TECHNICAL FIELD

The present disclosure relates to the field of communication technology, in particular, to a method for determining a Unified Transmission Configuration Indicator state, and a storage medium.

### BACKGROUND

In Multiple-Input Multiple-Output (MIMO) technology, the Multi Transmission Reception Point (M-TRP) can provide service for a terminal, so that the signal quality of the terminal can be better ensured, and the high-speed and high-capacity business requirements of the terminal can be met. In New Radio (NR), due to the different spatial positions of different TRPs, there are significant differences in the large-scale fading corresponding to each TRP. Therefore, when the transmission is conducted based on the M-TRP, it is necessary to indicate the corresponding beam information for each TRP separately.

### SUMMARY

According to a first aspect of the present disclosure, a method for determining a Unified Transmission Configuration Indicator state is provided. The method is performed by a terminal. The method includes: receiving first indication information sent by a network device, wherein the first indication information is configured to indicate a control resource pool index of at least one Control Resource Set, and wherein different control resource pool indexes correspond to different Unified Transmission Configuration Indicator (Unified TCI) state lists.

According to a second aspect of the present disclosure, a method for determining a Unified Transmission Configuration Indicator state is provided. The method is performed by a network device. The method includes: sending first indication information to a terminal, wherein the first indication information is configured to indicate a control resource pool index of at least one Control Resource Set, and wherein different control resource pool indexes correspond to different Unified Transmission Configuration Indicator (Unified TCI) state lists.

According to a third aspect of the present disclosure, an apparatus for determining a Unified Transmission Configuration Indicator state is provided. The apparatus is applied to a terminal. The apparatus includes: a receiving module configured to receive first indication information sent by a network device, wherein the first indication information is configured to indicate a control resource pool index of at least one Control Resource Set, and wherein different control resource pool indexes correspond to different Unified Transmission Configuration Indicator (Unified TCI) state lists.

According to a fourth aspect of the present disclosure, an apparatus for determining a Unified Transmission Configuration Indicator state is provided. The apparatus is applied to a network device. The apparatus includes: a sending module configured to send first indication information to a terminal, wherein the first indication information is configured to indicate a control resource pool index of at least one Control Resource Set, and wherein different control resource pool indexes correspond to different Unified Transmission Configuration Indicator (Unified TCI) state lists.

According to a fifth aspect of the present disclosure, a device for determining a Unified Transmission Configuration Indicator state is provided. The device includes: a processor and a memory configured to store instructions executable by the processor. The processor is configured to perform the method described in the first aspect and any of the embodiments thereof.

According to a sixth aspect of the present disclosure, a device for determining a Unified Transmission Configuration Indicator state is provided. The device includes: a processor and a memory configured to store instructions executable by the processor. The processor is configured to perform the method described in the second aspect and any of the embodiments thereof.

According to a seventh aspect of the present disclosure, a storage medium storing instructions is provided. When the instructions in the storage medium are executed by a processor of a terminal, the terminal is caused to perform the method described in the first aspect and any of the embodiments thereof.

According to an eighth aspect of the present disclosure, a storage medium storing instructions is provided. When the instructions in the storage medium are executed by a processor of a network device, the network device is caused to perform the method described in the second aspect and any of the embodiments thereof.

According to a ninth aspect of the present disclosure, a communication system including a terminal and a network device is provided. A first terminal device is configured to perform the method described in the first aspect and any of the embodiments thereof. The second terminal device is configured to perform the method described in the second aspect and any of the embodiments thereof.

It should be understood that the general description in the above and the detailed description in the following are only exemplary and explanatory, and cannot limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 is a schematic diagram of a wireless communication system according to one or more examples of the present disclosure.

FIG. 2 is a schematic diagram of a Unified TCI state list according to one or more examples of the present disclosure.

FIG. 3 is a flowchart of a method for determining a Unified TCI state according to one or more examples of the present disclosure.

FIG. 4 is a schematic diagram of a Unified TCI state list according to one or more examples of the present disclosure.

FIG. 5 is a schematic diagram of a Unified TCI state list according to one or more examples of the present disclosure.

FIG. 6 is a flowchart of a method for determining a Unified TCI state according to one or more examples of the present disclosure.

FIG. 7 is a flowchart of a method for determining a Unified TCI state according to one or more examples of the present disclosure.

FIG. 8 is a flowchart of a method for determining a Unified TCI state according to one or more examples of the present disclosure.

FIG. 9 is a block diagram of an apparatus for determining a Unified TCI state according to one or more examples of the present disclosure.

FIG. 10 is a block diagram of an apparatus for determining a Unified TCI state according to one or more examples of the present disclosure.

FIG. 11 is a block diagram of a device for determining a Unified TCI state according to one or more examples of the present disclosure.

FIG. 12 is a block diagram of a device for determining a Unified TCI state according to one or more examples of the present disclosure.

### DETAILED DESCRIPTION

Exemplary embodiments will be described in detail here, and the embodiments are shown in the drawings. When referring to the drawings, unless otherwise indicated, the same numbers in different drawings represent the same or similar elements. The embodiments described in the following do not represent all embodiments consistent with the present disclosure.

In Multiple-Input Multiple-Output (MIMO) technology, the Multi Transmission Reception Point (M-TRP) can provide service for a terminal, so that the signal quality of the terminal can be better ensured, and the high-speed and high-capacity business requirements of the terminal can be met. In New Radio (NR), due to the different spatial positions of different TRPs, there are significant differences in the large-scale fading corresponding to each TRP. Therefore, when the transmission is conducted based on the M-TRP, it is necessary to indicate the corresponding beam information for each TRP separately.

The downlink beam can be indicated through the Transmission Configuration Indicator (TCI) state, and the uplink beam can be indicated through the Space Relation Information (SRI). In consideration that in millimeter wave deployment, the downlink reception beam and the uplink emission beam of the terminal are often symmetrical, and the same beam can be used between different channels and signals of the terminal. Therefore, in order to reduce the signaling, the Unified Transmission Configuration Indicator state (Unified TCI state) has been introduced, which can provide the unified indicator for both uplink and downlink beams.

The Unified TCI state can be used to indicate that the uplink and downlink beams are only applicable to the Single Transmission Reception Point (S-TRP).

When the transmission is conducted based on the M-TRP and the Multi Downlink Control Information (M-DCI), determining the Unified TCI state corresponding to each TRP presents a technical challenge.

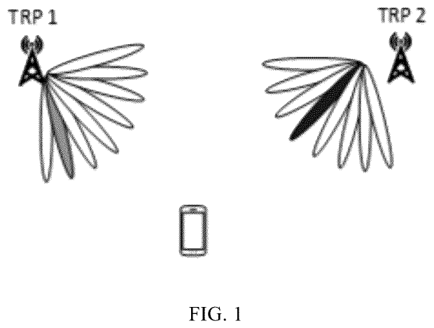

A method for determining the Unified TCI state provided in examples of the present disclosure can be applied to a wireless communication system shown in FIG. 1. As shown in FIG. 1, the wireless communication system includes a network device and a terminal. The terminal is connected to the network device through wireless resources and performs data transmission.

It can be understood that the communication system including the network device and the terminal shown in FIG. 1 is only a schematic explanation, and the wireless communication system can also include other network devices, for example, a core network device, a wireless relay device, and a wireless backhaul device, which are not shown in FIG. 1. The number of network devices and terminals included in the wireless communication system is not limited in examples of the present disclosure.

It can be further understood that the wireless communication system disclosed in examples of the present disclosure is a network that provides wireless communication functionality. Different communication technologies can be used in the wireless communication systems, such as code division multiple access (CDMA), wideband code division multiple access (WCDMA), time division multiple access (TDMA), frequency division multiple access (FDMA), orthogonal frequency division multiple access (OFDMA), single carrier FDMA (SC-FDMA), and carrier sense multiple access with collision avoidance. Networks can be divided according to factors such as different capacities, rates, and latencies, into 2G (generation) network, 3G network, 4G network, or a future evolved network, such as 5G network. 5G network can also be referred to as New Radio (NR). For the convenience of description, the wireless communication network is sometimes referred to as a network in the present disclosure.

Further, the network device involved in the present disclosure can also be referred to as a wireless access network device. The wireless access network device can be a base station, an evolved node B, a home base station, an access point (AP) in wireless fidelity (WIFI) system, a wireless relay node, a wireless backhaul node, a transmission point (TP) or a transmission and reception point (TRP), etc. The wireless access network device can also be gNB in NR system. Alternatively, the wireless access network device can be a component or a part of devices that constitute the base station. It should be understood that specific technologies and forms adopted by the network device are not limited in embodiments of the present disclosure. In the present disclosure, the network device can provide communication coverage for a specific geographic area and can communicate with terminals located within the coverage area (cell). In addition, in the V2X (Vehicle to Everything) communication system, the network device can also be an onboard device.

Further, the terminal involved in the present disclosure can also be referred to as a terminal device, user equipment (UE), a mobile station (MS), a mobile terminal (MT), etc., which are devices that provide voice and/or data connection to users. For example, the terminal can be a handheld device, a vehicle mounted device with wireless connection functions, etc. Some examples of terminals include smart mobile phones, customer premise equipment (CPE), pocket personal computers (PPCs), handheld computers, personal digital assistants (PDAs), laptops, tablets, wearable devices, or vehicle mounted devices. In addition, in the V2X (Vehicle to Everything) communication system, the terminal device can also be an onboard device. It should be understood that specific technologies and forms adopted by the terminal are not limited in embodiments of the present disclosure.

With the continuous development of wireless communication, the communication capability requirements are also increasing. In future oriented applications such as Augmented Reality (AR)/Virtual Reality (VR), V2X, IoT (Internet of Things), the ultra-high speed, the ultra-low latency, and the ultra-large bandwidth communication have become common scenarios. In order to meet the requirements, more and more new technologies are being proposed.

The MIMO technology has opened a new era for the development and utilization of spatial resources in mobile communication systems. Distributed MIMO is developed on the basis of traditional classical MIMO technology, expanding the application scope of the traditional MIMO. The distributed MIMO can not only be applied to single-cell cellular base station systems, but can also further replace multi-cell cellular base stations to form a cellular free mobile communication system in the form of distributed MU-MIMO (Multi-User Multiple-Input Multiple-Output), also known as cellfree technology. The cellfree technology can provide services to all users with the same time-frequency resources, without the need for traditional inter cell frequency partitioning, and the system resources can be dynamically scheduled in all aspects. As a result, the flexibility of existing system resource configuration can be improved and the resource utilization can be significantly increased.

In MIMO technology, M-TRP can provide services to a terminal, so that the signal quality of the terminal can be better ensured, and the high-speed and high-capacity business requirements of the terminal can be met. In New Radio (NR), due to the different spatial positions of different TRPs, there are significant differences in the large-scale fading corresponding to each TRP. Therefore, when the transmission is conducted based on the M-TRP, it is necessary to indicate the corresponding beam information for each TRP separately.

In the related art, the downlink beam can be indicated through the TCI state, and the uplink beam can be indicated through the SRI. In the millimeter wave deployment, the downlink reception beam and the uplink emission beam of the terminal are often symmetrical, and the same beam can be used between different channels and signals of the terminal. Therefore, in order to reduce the signaling, the Unified Transmission Configuration Indicator state (Unified TCI state) has been introduced in R17, which can provide the unified indicator for both uplink and downlink beams. The Unified TCI state indication has been standardized in R17, but only supports the single TRP connection.

In Multiple-Input Multiple-Output (MIMO) technology, the Multi Transmission Reception Point (M-TRP) can provide service for a terminal, so that the signal quality of the terminal can be better ensured, and the high-speed and high-capacity business requirements of the terminal can be met. In New Radio (NR), due to the different spatial positions of different TRPs, there are significant differences in the large-scale fading corresponding to each TRP. Therefore, when the transmission is conducted based on the M-TRP, it is necessary to indicate the corresponding beam information for each TRP separately.

In the related art, the downlink beam can be indicated through the Transmission Configuration Indicator (TCI) state, and the uplink beam can be indicated through the Space Relation Information (SRI). In consideration that in millimeter wave deployment, the downlink reception beam and the uplink emission beam of the terminal are often symmetrical, and the same beam can be used between different channels and signals of the terminal. Therefore, in order to reduce the signaling, the Unified Transmission Configuration Indicator state (Unified TCI state) has been introduced, which can provide the unified indicator for both uplink and downlink beams.

In the related art, the Unified TCI state is used to indicate that the uplink and downlink beams are only applicable to the Single Transmission Reception Point (S-TRP).

Explanations of the Unified TCI state for the S-TRP in R17 will be provided in the following.

The network device configures up to K Unified TCI states for a terminal through Radio Resource Control (RRC) signaling, and activate some of the Unified TCI states through the Medium Access Control Control Element (MAC CE). The Unified TCI information field in DCI can indicate an activated one of the Unified TCI states, serving as the Unified TCI state for TRP.

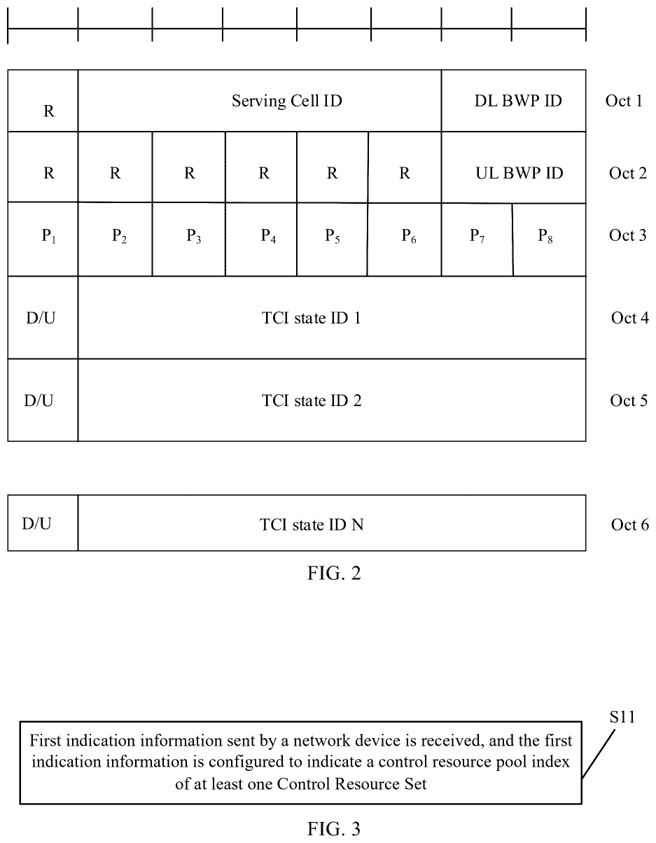

As shown in FIG. 2, the format diagram of a Unified TCI state list in MAC CE in the related art is illustrated.

In some examples, Oct in FIG. 2 means an 8-bit byte, which is composed of 8 bits. To be distinguished, different bytes are labeled as October 1, October 2, etc. October 1 can be abbreviated as a first byte, October 2 can be abbreviated as a second byte, and so on. It should be understood that the naming of the first byte, the second byte, etc. is only for a distinguish purpose and does not limit the protection scope of examples of the present disclosure.

Severing Cell ID: the Severing Cell ID is configured to indicate the identity of a service cell to which the MAC CE is applied, and the Severing Cell ID field can be 5 bits in length.

DL BWP ID: the DL BWP ID field contains an ID corresponding to the downlink bandwidth part for which the MAC CE is applicable. The BWP ID is given by the high-level parameter BWP ID specified in 3GPP TS 38.331. The DL BWP ID field is 2 bits in length.

UL BWP ID: the UL BWP ID field contains an ID corresponding to the uplink bandwidth part for which the MAC CE is applicable. The BWP ID is given by the high-level parameter BWP ID specified in 3GPP TS 38.331. The UL BWP ID field is 2 bits in length.

R: R(s) represent reserved bits.

Pi (which can be P1-P7): Pi is configured to indicate the Unified TCI state corresponding to each Unified TCI state group. If a value of Pi is set to 1, it means that the i^{th} Unified TCI state group corresponds to the Unified TCI state. If a value of Pi is set to 0, it means that the i^{th} Unified TCI state group only corresponds to the uplink or downlink Unified TCI state.

D/U: the D/U field is configured to indicate whether the Nth Unified TCI state group with TCI state ID N corresponds to the uplink Unified TCI state or the downlink Unified TCI state.

In the related art, the Unified TCI state indicates that the uplink and downlink beams are only applicable to S-TRP situations.

With the increasing maturity of distributed MIMO technology in the future, the number of TRPs for joint transmission will continue to increase. Currently, R18 has started discussing up to 4 TRP connections. The present disclosure proposes solutions for the Unified TCI state indication in the M-TRP scenario based on M-DCI.

Examples of the present disclosure provide a method for determining a Unified TCI state. The terminal receives first indication information sent by the network device, and the first indication information is configured to indicate at least one control resource pool index of a Control Resource Set. In some examples, different control resource pool indexes correspond to different Unified Transmission Configuration Indicator (Unified TCI) state lists. Therefore, in the scenario where M-TRP and M-DCI are supported, the Unified TCI state list corresponding to each TRP can be determined based on the control resource pool index of the Control Resource Set corresponding to each TRP.

FIG. 3 is a flowchart of a method for determining a Unified TCI state according to one or more examples of the present disclosure. As shown in FIG. 3, the method for determining the Unified TCI state is performed by a terminal, and the method includes the following steps.

In step S11, first indication information sent by a network device is received, and the first indication information is configured to indicate a control resource pool index of at least one Control Resource Set.

In some examples, different control resource pool indexes correspond to different Unified TCI state lists.

In some examples, the control resource pool index has a corresponding relationship with the Unified TCI state list. The Unified TCI state list includes Unified TCI states corresponding to different Unified TCI state groups. Different Unified TCI state groups can correspond to different Unified TCI states. That different Unified TCI state groups can correspond to different Unified TCI states means that the Unified TCI states corresponding to different Unified TCI state groups are all different, or that the Unified TCI states corresponding to some Unified TCI state groups are different, while the Unified TCI states corresponding to the other Unified TCI state groups are the same.

In examples of the present disclosure, the terminal receives the first indication information sent by the network device, which is configured to indicate the control resource pool index of at least one Control Resource Set. In some examples, different control resource pool indexes correspond to different Unified Transmission Configuration Indicator (Unified TCI) state lists. Therefore, in the scenario where M-TRP and M-DCI are supported, the Unified TCI state list corresponding to each TRP can be determined based on the control resource pool index of the Control Resource Set corresponding to each TRP.

In the method for determining the Unified TCI state provided in examples of the present disclosure, the first indication information is included in the MAC CE. In examples of the present disclosure, the signaling overhead can be reduced by including the first indication information in the MAC CE.

In the method for determining the Unified TCI state provided in examples of the present disclosure, the first indication information includes a first information field, and the first information field is configured to indicate the control resource pool index of at least one Control Resource Set.

In examples of the present disclosure, by adding the information field in the MAC CE to indicate the control resource pool index of at least one Control Resource Set, the control resource pool index can be associated with the Unified TCI state list, so that the Unified TCI state list corresponding to the TRP can be determined based on the control resource pool index of the TRP.

In the method for determining the Unified TCI state provided in examples of the present disclosure, different bit values corresponding to different bit overhead of the first information field are configured to indicate different Unified TCI state lists activated by the MAC CE.

In some examples, when the bit overhead of the first information field is one bit, and when the bit value corresponding to the first information field is a first value (e.g. 0), the first information field indicates a first Unified TCI state list activated by the MAC CE. When the bit value corresponding to the first information field is a second value (e.g. 1), the first information field indicates a second Unified TCI state list activated by the MAC CE.

In some examples, when the bit overhead of the first information field is two bits, and when the bit value corresponding to the first information field is a first value (e.g. 00), the first information field indicates a first Unified TCI state list activated by the MAC CE. When the bit value corresponding to the first information field is a second value (e.g. 01), the first information field indicates a second Unified TCI state list activated by the MAC CE. When the bit value corresponding to the first information field is a third value (e.g. 10), the first information field indicates a third Unified TCI state list activated by the MAC CE. When the bit value corresponding to the first information field is a fourth value (e.g. 11), the first information field indicates a fourth Unified TCI state list activated by the MAC CE.

In examples of the present disclosure, different bit values corresponding to different bit overhead of the first information field represent different control resource pool indexes, different control resource pool indexes correspond to different control resource pools, and different control resource pools correspond to different Unified TCI state lists.

In some examples, when the bit overhead of the first information field is one bit, the when the bit value corresponding to the first information field is the first value (e.g. 0), that is, when the control resource pool index is the first value (e.g. 0), the CORESET_0 is indicated, which corresponds to the first Unified TCI state list. When the bit value corresponding to the first information field is the second value (e.g. 1), that is, when the control resource pool index is the second value (e.g. 1), the CORESET_1 is indicated, which corresponds to the second Unified TCI state list.

In examples of the present disclosure, different bit values corresponding to different bit overhead of the first information field are used to indicate different Unified TCI state lists activated by the MAC CE, thereby determining the Unified TCI state list corresponding to the TRP associated with the control resource pool index of the at least one Control Resource Set indicated by the first information field, and improving the signal quality of the M-TRP transmission that is based on the Unified TCI state.

In the method for determining the Unified TCI state provided in examples of the present disclosure, the bit overhead of the first information field is configured by high-level signaling or specified in a protocol.

In examples of the present disclosure, when the bit overhead of the first information field has been configured by the high-level signaling or specified in the protocol, the maximum number of TRPs that can be connected supported by the terminal can be implicitly determined based on the bit overhead of the first information field.

In some examples, if the bit overhead of the first information field is one bit, it can be determined that the maximum number of TRPs that can be connected supported by the terminal is 2.

In some examples, if the bit overhead of the first information field is two bits, it can be determined that the maximum number of TRPs that can be connected supported by the terminal is 4.

In some examples, if the bit overhead of the first information field is three bits, it can be determined that the maximum number of TRPs that can be connected supported by the terminal is 8.

In addition to the bit overhead explained in examples mentioned above, the first information field in examples of the present disclosure can also include other bit overhead, and examples of the present disclosure do not limit this.

In some examples, the bit overhead of the first information field includes [log₂M] bits, where M is the maximum number of TRPs that can be connected supported by the terminal.

In the method for determining the Unified TCI state provided in examples of the present disclosure, the bit(s) occupied by the first information field is/are reserved bits in the MAC CE. In examples of the present disclosure, when the bit(s) occupied by the first information field is/are reserved bits in the MAC CE, the signaling overhead of the MAC CE can be reduced.

In the method for determining the Unified TCI state provided in examples of the present disclosure, the bit(s) occupied by the first information field is/are one or two of reserved bits in the MAC CE.

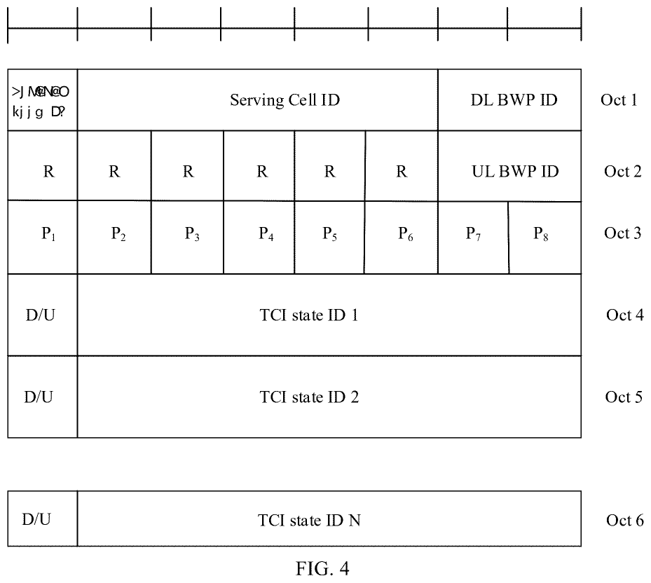

In some examples, as shown in FIG. 4, when the bit(s) occupied by the first information field is/are one reserved bit of the reserved bits in the MAC CE, the position of the reserved bit can be located at a first reserved bit of a first byte in the MAC CE.

In some examples, as shown in FIG. 5, when the bit(s) occupied by the first information field is/are two reserved bits of the reserved bits in the MAC CE, the positions of these two reserved bits can be located at a first reserved bit and a second reserved bit of a second byte in the MAC CE.

In the method for determining the Unified TCI state provided in examples of the present disclosure, second indication information sent by the network device is received, and the second indication information is configured to indicate at least one Unified TCI state. Based on a control resource pool index corresponding to the Unified TCI state, a Unified TCI state list in which the Unified TCI state indicated by the second indication information is included is determined.

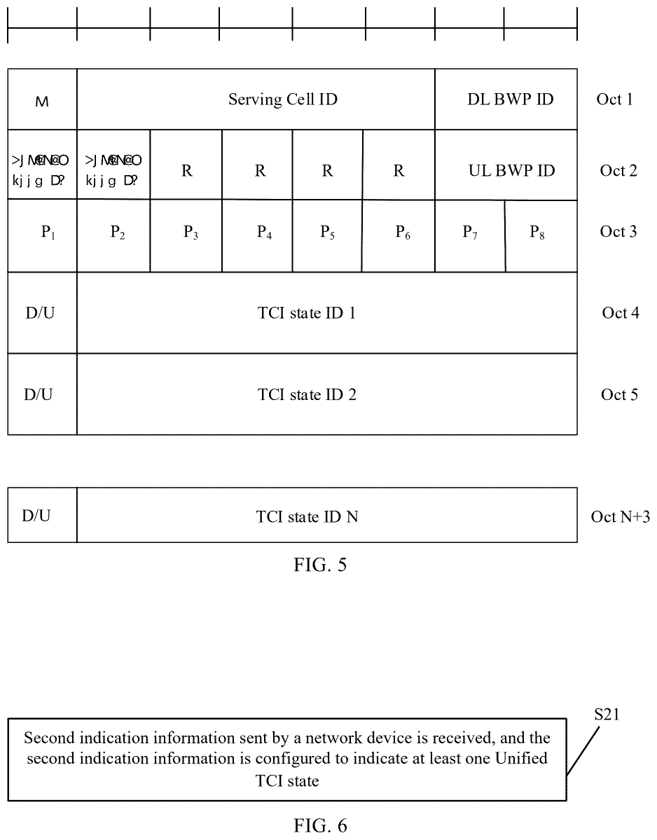

As shown in FIG. 6, a flowchart of a method for determining a Unified TCI state according to one or more examples of the present disclosure is illustrated, and the method includes the following steps.

In step S21, second indication information sent by a network device is received, and the second indication information is configured to indicate at least one Unified TCI state.

In some examples, the at least one Unified TCI state corresponds to at least one control resource pool, and the at least one Unified TCI state is included in the Unified TCI state list corresponding to the control resource pool index of the control resource pool. The control resource pool includes at least one Control Resource Set.

In some examples, if the control resource pool index of the control resource pool corresponding to the Unified TCI state indicated by the second indication information is 1, then the Unified TCI state indicated by the second indication information is included in the Unified TCI state list corresponding to the control resource pool index of 1.

In examples of the present disclosure, the terminal receives the second indication information and determines the corresponding control resource pool index based on the at least one Unified TCI state indicated by the second indication information. The at least one Unified TCI state indicated by the second indication information is included in the Unified TCI state list corresponding to the control resource pool index associated with the at least one Unified TCI state. Due to the fact that each control resource pool index is associated with a corresponding TRP, the Unified TCI state list corresponding to each TRP in multiple TRPs in the M-DCI scenario can be determined based on examples of the present disclosure.

In the method for determining the Unified TCI state provided in examples of the present disclosure, the second indication information is carried in a TCI indication field in the DCI.

In the method for determining the Unified TCI state provided in examples of the present disclosure, the Unified TCI state includes an uplink and downlink joint TCI state, or a separate TCI state.

In some examples, the first indication information further includes a third information field, and the third information field is configured to indicate whether the separate TCI state is an uplink TCI state or a downlink TCI state.

It should be noted that the example shown in FIG. 6 can be implemented separately, that is, when the example shown in FIG. 6 is implemented separately, the terminal device can receive the second indication information, which is configured to indicate at least one Unified TCI state, sent by the network device, but the present disclosure does not limit whether the activated Unified TCI state lists corresponding to different control resource pool indexes are needed, or how the Unified TCI state lists corresponding to different control resource pool indexes are activated. The example shown in FIG. 6 can also be implemented in conjunction with other examples disclosed in the present disclosure. In some examples, the example shown in FIG. 6 can be implemented in conjunction with the example shown in FIG. 3. That is, the terminal device can receive the first indication information, which is configured to indicate the control resource pool index of at least one Control Resource Set, sent by the network device, where different control resource pool indexes correspond to different Unified TCI state lists. The terminal device also receives the second indication information, which is configured to indicate at least one Unified TCI state, sent by the network device. In examples of the present disclosure, the first indication information and the second indication information can be carried by different signaling. For example, the first indication information is included in the MAC CE and the second indication information is included in the DCI or RRC or other signaling. In some examples, the first indication information and the second indication information can also be carried by the same signaling, and examples of the present disclosure do not limit this.

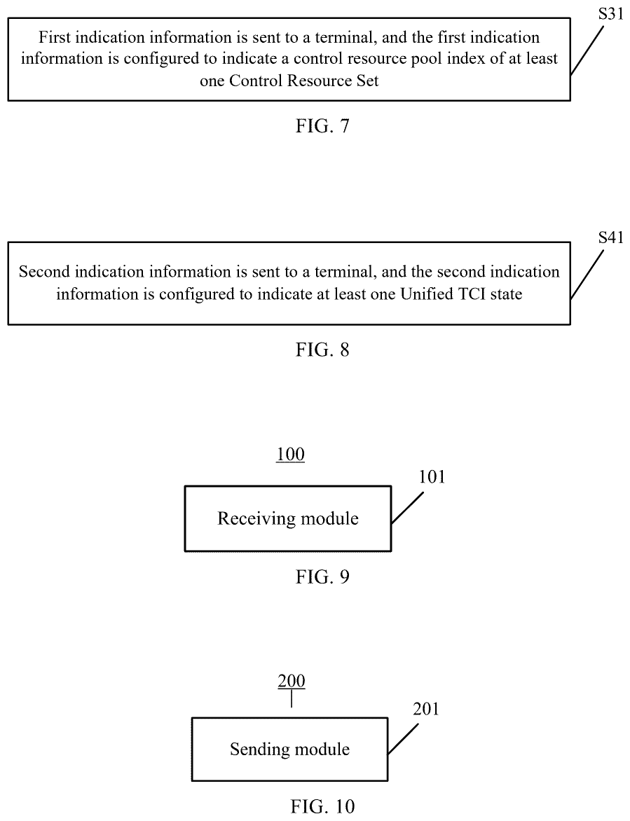

FIG. 7 is a flowchart of a method for determining a Unified TCI state according to one or more examples of the present disclosure. As shown in FIG. 7, the method for determining the Unified TCI state is performed by a network device, and the method includes the following steps.

In step S31, first indication information is sent to a terminal, and the first indication information is configured to indicate a control resource pool index of at least one Control Resource Set.

In some examples, different control resource pool indexes correspond to different Unified TCI state lists.

In some examples, the control resource pool index has a corresponding relationship with the Unified TCI state list. The Unified TCI state list includes Unified TCI states corresponding to different Unified TCI state groups. The specific explanations can refer to the explanations for step S11, which will not be repeated here.

In examples of the present disclosure, the terminal receives the first indication information sent by the network device, which is configured to indicate the control resource pool index of at least one Control Resource Set. In some examples, different control resource pool indexes correspond to different Unified Transmission Configuration Indicator (Unified TCI) state lists. Therefore, in the scenario where M-TRP and M-DCI are supported, the Unified TCI state list corresponding to each TRP can be determined based on the control resource pool index of the Control Resource Set corresponding to each TRP.

In the method for determining the Unified TCI state provided in examples of the present disclosure, the first indication information is included in the MAC CE. In examples of the present disclosure, the signaling overhead can be reduced by including the first indication information in the MAC CE.

In the method for determining the Unified TCI state provided in examples of the present disclosure, the first indication information includes a first information field, and the first information field is configured to indicate the control resource pool index of at least one Control Resource Set.

In examples of the present disclosure, by adding the information field in the MAC CE to indicate the control resource pool index of at least one Control Resource Set, the control resource pool index can be associated with the Unified TCI state list, so that the Unified TCI state list corresponding to the TRP can be determined based on the control resource pool index of the TRP.

In the method for determining the Unified TCI state provided in examples of the present disclosure, different bit values corresponding to different bit overhead of the first information field are configured to indicate different Unified TCI state lists activated by the MAC CE. The specific explanations can refer to the explanations for step S11, which will not be repeated here.

In some examples, when the bit overhead of the first information field is one bit, and when the bit value corresponding to the first information field is 0, the first information field indicates a first Unified TCI state list activated by the MAC CE. When the bit value corresponding to the first information field is 1, the first information field indicates a second Unified TCI state list activated by the MAC CE.

In some examples, when the bit overhead of the first information field is two bits, and when the bit value corresponding to the first information field is ‘00’, the first information field indicates a first Unified TCI state list activated by the MAC CE. When the bit value corresponding to the first information field is ‘01’, the first information field indicates a second Unified TCI state list activated by the MAC CE. When the bit value corresponding to the first information field is ‘10’, the first information field indicates a third Unified TCI state list activated by the MAC CE. When the bit value corresponding to the first information field is ‘11’, the first information field indicates a fourth Unified TCI state list activated by the MAC CE.

In examples of the present disclosure, different bit values corresponding to different bit overhead of the first information field represent different control resource pool indexes, different control resource pool indexes correspond to different control resource pools, and different control resource pools correspond to different Unified TCI state lists.

In some examples, when the bit overhead of the first information field is one bit, the when the bit value corresponding to the first information field is 0, that is, when the control resource pool index is 0, the CORESET_0 is indicated, which corresponds to the first Unified TCI state list. When the bit value corresponding to the first information field is 1, that is, when the control resource pool index is 1, the CORESET_1 is indicated, which corresponds to the second Unified TCI state list.

In examples of the present disclosure, different bit values corresponding to different bit overhead of the first information field are used to indicate different Unified TCI state lists activated by the MAC CE, thereby determining the Unified TCI state list corresponding to the TRP associated with the control resource pool index of the at least one Control Resource Set indicated by the first information field.

In the method for determining the Unified TCI state provided in examples of the present disclosure, the bit overhead of the first information field is configured by high-level signaling or specified in a protocol.

In examples of the present disclosure, when the bit overhead of the first information field has been configured by the high-level signaling or specified in the protocol, the maximum number of TRPs that can be connected supported by the terminal can be implicitly determined based on the bit overhead of the first information field.

In some examples, if the bit overhead of the first information field is one bit, it can be determined that the maximum number of TRPs that can be connected supported by the terminal is 2.

In some examples, if the bit overhead of the first information field is two bits, it can be determined that the maximum number of TRPs that can be connected supported by the terminal is 4.

In some examples, if the bit overhead of the first information field is three bits, it can be determined that the maximum number of TRPs that can be connected supported by the terminal is 8.

In addition to the bit overhead explained in examples mentioned above, the first information field in examples of the present disclosure can also include other bit overhead, and embodiments of the present disclosure do not limit this.

In some examples, the bit overhead of the first information field includes [log₂M] bits, where M is the maximum number of TRPs that can be connected supported by the terminal.

In the method for determining the Unified TCI state provided in examples of the present disclosure, the bit(s) occupied by the first information field is/are reserved bits in the MAC CE.

In examples of the present disclosure, when the bit(s) occupied by the first information field is/are reserved bits in the MAC CE, the signaling overhead of the MAC CE can be reduced.

In the method for determining the Unified TCI state provided in examples of the present disclosure, the bit(s) occupied by the first information field is/are one or two of reserved bits in the MAC CE.

In some examples, when the bit(s) occupied by the first information field is/are one reserved bit of the reserved bits in the MAC CE, the position of the reserved bit can be located at a first reserved bit of a first byte in the MAC CE.

In some examples, when the bit(s) occupied by the first information field is/are two reserved bits of the reserved bits in the MAC CE, the positions of these two reserved bits can be located at a first reserved bit and a second reserved bit of a second byte in the MAC CE.

In the method for determining the Unified TCI state provided in examples of the present disclosure, the network device sends second indication information to the terminal, and the second indication information is configured to indicate at least one Unified TCI state. The terminal determines, based on a control resource pool index corresponding to the Unified TCI state, a Unified TCI state list in which the Unified TCI state indicated by the second indication information is included.

FIG. 8 is a flowchart of a method for determining a Unified TCI state according to one or more examples of the present disclosure. As shown in FIG. 8, the method includes the following steps.

In step S41, second indication information is sent to a terminal, and the second indication information is configured to indicate at least one Unified TCI state.

In some examples, the at least one Unified TCI state corresponds to at least one control resource pool, and the at least one Unified TCI state is included in the Unified TCI state list corresponding to the control resource pool index of the control resource pool. The control resource pool includes at least one Control Resource Set.

In some examples, if the control resource pool index of the control resource pool corresponding to the Unified TCI state indicated by the second indication information is 1, then the Unified TCI state indicated by the second indication information is included in the Unified TCI state list corresponding to the control resource pool index of 1.

In examples of the present disclosure, the terminal receives the second indication information and determines the corresponding control resource pool index based on the at least one Unified TCI state indicated by the second indication information. The at least one Unified TCI state indicated by the second indication information is included in the Unified TCI state list corresponding to the control resource pool index associated with the at least one Unified TCI state. Due to the fact that each control resource pool index is associated with a corresponding TRP, the Unified TCI state list corresponding to each TRP in multiple TRPs in the M-DCI scenario can be determined based on examples of the present disclosure.

In the method for determining the Unified TCI state provided in examples of the present disclosure, the second indication information is carried in a Unified TCI indication field in the DCI.

In the method for determining the Unified TCI state provided in examples of the present disclosure, the Unified TCI state includes an uplink and downlink joint TCI state, or a separate TCI state.

In some examples, the first indication information further includes a third information field, and the third information field is configured to indicate whether the separate TCI state is an uplink TCI state or a downlink TCI state.

It should be noted that the examples shown in FIG. 8 can be implemented separately, that is, when the example shown in FIG. 8 is implemented separately, the network device can send the second indication information, which is configured to indicate at least one Unified TCI state, to the terminal, but the present disclosure does not limit whether the activated Unified TCI state lists corresponding to different control resource pool indexes are needed, or how the Unified TCI state lists corresponding to different control resource pool indexes are activated. The example shown in FIG. 8 can also be implemented in conjunction with other examples disclosed in the present disclosure. In some examples, the example shown in FIG. 8 can be implemented in conjunction with the example shown in FIG. 7. That is, the network device sends the first indication information, which is configured to indicate the control resource pool index of at least one Control Resource Set, to the terminal, where different control resource pool indexes correspond to different Unified TCI state lists. The network device can also send the second indication information, which is configured to indicate at least one Unified TCI state, to the terminal device. In examples of the present disclosure, the first indication information and the second indication information can be carried by different signaling. For example, the first indication information is included in the MAC CE and the second indication information is included in the DCI or RRC or other signaling. In some examples, the first indication information and the second indication information can also be carried by the same signaling, and examples of the present disclosure do not limit this.

It should be noted that those skilled in the art can understand that various embodiments/implementations mentioned in the present disclosure can be implemented in conjunction with the aforementioned embodiments or independently. Whether implemented alone or in conjunction with the aforementioned embodiments, the implementation principles are similar. In the present disclosure, some embodiments are described as being implemented together, and those skilled in the art can understand that such embodiments do not limit the present disclosure.

Based on the same concept, examples of the present disclosure also provide an apparatus for determining a Unified TCI state.

It can be understood that the apparatus for determining the Unified TCI state provided by examples of the present disclosure include a hardware structure and/or a software module corresponding to each function in order to realize the above functions. In combination with the units and algorithm steps in examples disclosed in examples of the present disclosure, examples of the present disclosure can be implemented in the form of hardware or a combination of hardware and computer software. Whether a function is implemented in the form of hardware or computer software driving the hardware depends on a specific application and design constraints of a technical solution. Those skilled in the art can use different methods to implement the described functions for each specific application, but such an implementation should not be considered beyond the scope of technical solutions of examples of the present disclosure.

FIG. 9 is a block diagram of an apparatus for determining a Unified TCI state according to one or more examples of the present disclosure. Referring to FIG. 9, the apparatus includes a receiving module 101. The apparatus 100 for determining the Unified TCI state is applied to a terminal.

The receiving module 101 is configured to receive the first indication information sent by the network device, and the first indication information is configured to indicate a control resource pool index of at least one Control Resource Set. In some examples, different control resource pool indexes correspond to different Unified Transmission Configuration Indicator (Unified TCI) state lists.

In some examples, the first indication information is included in Medium Access Control Control Element (MAC CE).

In some examples, the first indication information includes a first information field, and the first information field is configured to indicate the control resource pool index of the at least one Control Resource Set.

In some examples, different bit values corresponding to different bit overhead of the first information field are configured to indicate different Unified TCI state lists activated by the MAC CE.

In some examples, the bit overhead of the first information field is configured by high-level signaling or specified in a protocol.

In some examples, a bit occupied by the first information field is a reserved bit in the MAC CE.

In some examples, the bit occupied by the first information field is one or two reserved bits in the MAC CE.

In some examples, the receiving module 101 is further configured to receive second indication information sent by the network device. The second indication information is configured to indicate at least one Unified TCI state, the at least one Unified TCI state corresponds to at least one control resource pool, the at least one Unified TCI state is included in the Unified TCI state list corresponding to the control resource pool index of the control resource pool, and the control resource pool includes the at least one Control Resource Set.

In some examples, the second indication information is included in a Unified TCI indication field in the DCI.

As for the apparatus in the above examples, specific ways in which each module performs the function has been described in detail in the method examples, which will not be described in detail here.

FIG. 10 is a block diagram of an apparatus for determining a Unified TCI state according to one or more examples of the present disclosure. Referring to FIG. 10, the apparatus includes a sending module 201. The apparatus 200 for determining the Unified TCI state is applied to a network device.

The sending module 201 is configured to send the first indication information to the terminal, and the first indication information is configured to indicate a control resource pool index of at least one Control Resource Set. In some examples, different control resource pool indexes correspond to different Unified Transmission Configuration Indicator (Unified TCI) state lists.

In some examples, the first indication information is included in Medium Access Control Control Element (MAC CE).

In some examples, the first indication information includes a first information field, and the first information field is configured to indicate the control resource pool index of the at least one Control Resource Set.

In some examples, different bit values corresponding to different bit overhead of the first information field are configured to indicate different Unified TCI state lists activated by the MAC CE.

In some examples, the bit overhead of the first information field is configured by high-level signaling or specified in a protocol.

In some examples, a bit occupied by the first information field is a reserved bit in the MAC CE.

In some examples, the bit occupied by the first information field is one or two reserved bits in the MAC CE.

In some examples, the sending module 201 is further configured to send second indication information to the terminal. The second indication information is configured to indicate at least one Unified TCI state, the at least one Unified TCI state corresponds to at least one control resource pool, the at least one Unified TCI state is included in the Unified TCI state list corresponding to the control resource pool index of the control resource pool, and the control resource pool includes the at least one Control Resource Set.

In some examples, the second indication information is included in a Unified TCI indication field in the DCI.

It should be noted that the various modules/units involved in the apparatus 100 for determining the Unified TCI state and the apparatus 200 for determining the Unified TCI state disclosed in examples are only for illustrative purposes and are not limited to them. In some examples, the apparatus 100 for determining the Unified TCI state in examples of the present disclosure can further include a sending unit and/or a processing unit, and the apparatus 200 for determining the Unified TCI state can further include a receiving unit and/or a processing unit. In some examples, the units included in the apparatus 100 for determining the Unified TCI state and the apparatus 200 for determining the Unified TCI state can interact with each other or with other network element devices.

As for the apparatus in the above examples, specific ways in which each module performs the function has been described in detail in the method examples, which will not be described in detail here.

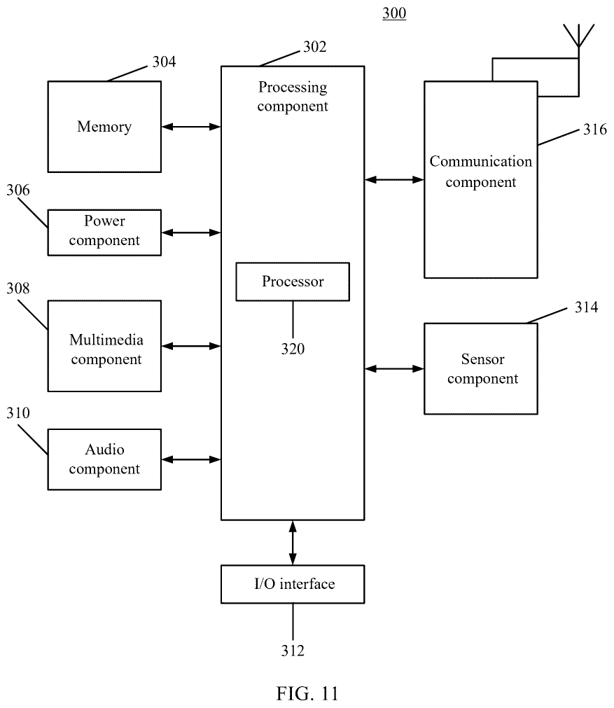

FIG. 11 is a block diagram of a device for determining a Unified TCI state according to one or more examples of the present disclosure. The device 300 can be a mobile phone, a computer, a digital broadcasting user device, a messaging device, a game console, a tablet device, a medical device, a fitness device, a personal digital assistant, etc.

Referring to FIG. 11, device 300 can include at least one of the following components:
a processing component 302, a memory 304, a power component 306, a multimedia component 308, an audio component 310, an input/output (I/O) interface 312, a sensor component 314, and a communication component 316.

The processing component 302 typically controls the overall operation of the device 300, such as operations associated with display, telephone call, data communication, camera operation, and recording operations. The processing component 302 may include one or more processors to execute instructions to complete all or part of the methods described above. In addition, the processing component 302 may include one or more modules to facilitate interactions between the processing component 302 and other components. For example, the processing component 302 may include a multimedia module to facilitate interaction between the multimedia component 308 and the processing component 302.

The memory 304 is configured to store various types of data to support operations in the device 300. Examples of such data include instructions, contact data, phone book data, messages, pictures, videos, and the like for any application or method operating on the device 300. The memory 304 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 306 provides power for various components of the device 300. The power component 306 may include a power management system, one or more power supplies, and other components associated with generating, managing, and distributing power for the device 300.

The multimedia component 308 includes a display screen providing an output interface between the device 300 and the user. In some examples, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some examples, the multimedia component 308 includes a front camera and/or a rear camera. When the device 300 is in operation mode, such as shooting mode or video mode, the front camera and/or rear camera can receive external multimedia data. Each front camera and rear camera can be a fixed optical lens system or have focal length and optical zoom capability.

The audio component 310 is configured to output and/or input audio signals. For example, the audio component 310 includes a microphone (MIC), which is configured to receive an external audio signal when the device 300 is in an operation mode, such as a calling mode, a recording mode, and a voice recognition mode. The received audio signal may be further stored in memory 304 or transmitted via communication component 316. In some examples, the audio component 310 also includes a speaker for outputting audio signals.

The I/O interface 312 provides an interface between the processing component 302 and peripheral interface modules, which can be a keyboard, click wheel, button, etc. These buttons may include, but are not limited to, the Home button, Volume button, Start button, and Lock button.

The sensor component 314 includes one or more sensors for providing various aspects of condition evaluation for the device 300. For example, the sensor component 314 can detect an open/closed state of the device 300, relative positioning of the components. The component is, for example, a display and a keypad of the device 300. The sensor component 314 can also detect changes in the position of the device 300 or one component of the device 300, presence or absence of the user's contact with the device 300, orientation or acceleration/deceleration of the device 300 and temperature change of the device 300. The sensor component 314 may include a proximity sensor configured to detect the presence of nearby objects without any physical contact. The sensor component 314 may also include a light sensor, such as a CMOS or CCD image sensor, for use in imaging applications. In some examples, the sensor component 314 may also include an acceleration sensor, a gyroscope sensor, a magnetic sensor, a pressure sensor, or a temperature sensor.

The communication component 316 is configured to facilitate wired or wireless communication between the device 300 and other devices. The device 300 can access wireless networks based on communication standards, such as WiFi, 2G or 3G, or a combination thereof. In some examples, the communication component 316 receives a broadcast signal or broadcast related information from an external broadcast management system via a broadcast channel. In some examples, the communication component 316 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some examples, the device 300 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some examples, a non-transitory computer-readable storage medium including instructions is also provided, such as the memory 304 including instructions, which can be executed by the processor 320 of the device 300 to complete above methods. For example, the non-transitory computer-readable storage medium can be ROM, random access memory (RAM), CD-ROM, tapes, floppy disks, optical data storage devices, etc.

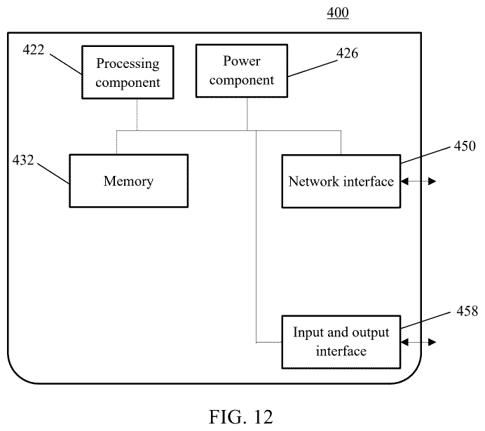

FIG. 12 is a block diagram of a device for determining a Unified TCI state according to one or more examples of the present disclosure. The device 400 can be provided as a network device. Referring to FIG. 12, the device 400 includes a processing component 422, which further includes one or more processors, as well as memory resources represented by a memory 432, for storing instructions that can be executed by the processing component 422, such as application programs. The application programs stored in memory 432 can include one or more modules corresponding to a set of instructions. In addition, the processing component 422 is configured to execute instructions to implement the method described above.

The device 400 can further include a power component 426 configured to perform power management of the device 400, a wired or wireless network interface 450 configured to connect the device 400 to the network, and an input and output (I/O) interface 458. The device 400 can operate operating systems stored in the memory 432, such as Windows Server ™, Mac OS X™, Unix™, Linux™, FreeBSD™, or similar systems.

In some examples, a non-transitory computer-readable storage medium including instructions is also provided, such as the memory 432 including instructions, which can be executed by the processing component 422 of the device 400 to complete above methods. For example, the non-transitory computer-readable storage medium can be ROM, random access memory (RAM), CD-ROM, tapes, floppy disks, optical data storage devices, etc.

It should be further understood that “multiple” in the present disclosure refers to two or more, and other quantifiers are similar. “And/or” describes an association relationship between associated objects, indicating that there can be three relationships. For example, A and/or B can indicate that A alone, both A and B, or B alone. The character “/” generally indicates that the associated objects have an “or” relationship. The singular forms “one”, “a” and “the” are also intended to include majority forms, unless the context clearly indicates otherwise.

It can be further understood that the meanings of words such as “in response to” and “if” mentioned in the present disclosure depend on the context and the actual application scenario. For example, the word “in response to” used herein can be interpreted as “when”, “while”, or “if”.

It should be further understood that the terms “first”, “second” and the like are used to describe various kinds of information, but such information should not be limited to these terms. These terms are only used to distinguish the same type of information from each other, and do not indicate a specific order or importance. In fact, the expressions “first” and “second” can be used interchangeably. For example, without departing from the scope of the present disclosure, the first information can also be referred to as the second information, and similarly, the second information can also be referred to as the first information.

It should be further understood that although the operations in examples of the present disclosure are described in a specific order in the drawings, they should not be understood that these operations are required to be performed in the specific order or serial order shown, or that all of the operations shown are required to be performed to achieve the desired results. Multitasking and parallel processing may be advantageous in a particular environment.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure.

It should be understood that the present disclosure is not limited to the precise structure described above and shown in the drawings, and various modifications and changes can be made without departing from its scope. The scope of the present disclosure is limited only by the appended claims.

1. A method for determining a Unified Transmission Configuration Indicator (Unified TCI) state, comprising:
receiving, by a terminal, first indication information sent by a network device, wherein the first indication information is configured to indicate a control resource pool index of at least one Control Resource Set, and
wherein different control resource pool indexes correspond to different Unified TCI state lists.

2. The method according to claim 1, wherein the first indication information is comprised in Medium Access Control Control Element (MAC CE).

3. The method according to claim 2, wherein the first indication information comprises a first information field, and the first information field is configured to indicate the control resource pool index of the at least one Control Resource Set.

4. The method according to claim 3, wherein different bit values corresponding to different bit overhead of the first information field are configured to indicate different Unified TCI state lists activated by the MAC CE.

5. The method according to claim 4, wherein the bit overhead of the first information field is configured by high-level signaling or specified in a protocol.

6. The method according to claim 3, wherein a bit occupied by the first information field comprises a reserved bit in the MAC CE.

7. The method according to claim 6, wherein the bit occupied by the first information field comprise one or two reserved bits in the MAC CE.

8. The method according to claim 1, further comprising:
receiving, by the terminal, second indication information sent by the network device, wherein the second indication information is configured to indicate at least one Unified TCI state, and wherein the at least one Unified TCI state corresponds to at least one control resource pool, the at least one Unified TCI state is comprised in the Unified TCI state list corresponding to the control resource pool index of the control resource pool, and the control resource pool comprises the at least one Control Resource Set.

9. The method according to claim 8, wherein the second indication information is comprised in a Unified TCI indication field in Downlink Control Information (DCI).

10. A method for determining a Unified Transmission Configuration Indicator (Unified TCI) state, comprising:
sending, by a network device, first indication information to a terminal, wherein the first indication information is configured to indicate a control resource pool index of at least one Control Resource Set, and
wherein different control resource pool indexes correspond to different Unified TCI state lists.

11. The method according to claim 10, wherein the first indication information is comprised in Medium Access Control Control Element (MAC CE).

12. The method according to claim 11, wherein the first indication information comprises a first information field, and the first information field is configured to indicate the control resource pool index of the at least one Control Resource Set.

13. The method according to claim 12, wherein different bit values corresponding to different bit overhead of the first information field are configured to indicate different Unified TCI state lists activated by the MAC CE.

14. The method according to claim 13, wherein the bit overhead of the first information field is configured by high-level signaling or specified in a protocol, and a bit occupied by the first information field comprises at least one reserved bit in the MAC CE.

15-16. (canceled)

17. The method according to claim 10, further comprising:
sending, by the network device, second indication information to the terminal, wherein the second indication information is configured to indicate at least one Unified TCI state, and
wherein the at least one Unified TCI state corresponds to at least one control resource pool, the at least one Unified TCI state is comprised in the Unified TCI state list corresponding to the control resource pool index of the control resource pool, and the control resource pool comprises the at least one Control Resource Set.

18. The method according to claim 17, wherein the second indication information is comprised in a Unified TCI indication field in Downlink Control Information (DCI).

19-20. (canceled)

21. A communication device, comprising:
a processor; and
a memory configured to store instructions executable by the processor;
wherein the processor is configured to execute the instructions to perform the method according to claim 1.

22. A communication device, comprising:
a processor; and
a memory configured to store instructions executable by the processor;
wherein the processor is configured to execute the instructions to perform the method according to claim 10.

23. A non-transitory computer-readable_storage medium having instructions stored thereon, which when executed by a processor of the terminal, cause the terminal to perform the method according to claim 1.

24. A non-transitory computer-readable_storage medium having instructions stored thereon, which when executed by a processor of the network device, cause the network device to perform the method according to claim 10.

25. (canceled)
